(19) United States
(12) Patent Application Publication
(10) Pub. No.: US 2010/0201270 A1
(43) Pub. Date: Aug. 12, 2010

(54) LIGHT EMITTING DIODE LIGHT TUBE AND AC SWITCHING POWER SUPPLY THEREOF

(75) Inventor: CHENG-HSIUNG KUO, HSIN-TIEN CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: LEDTECH ELECTRONICS, HSIN-TIEN CITY (TW)

(21) Appl. No.: 12/689,420

(22) Filed: Jan. 19, 2010

(30) Foreign Application Priority Data
Feb. 10, 2009 (TW) 098201893

(51) Int. Cl. H05B 37/02; H01J 7/44; H02M 3/22

(52) U.S. Cl. 315/51; 307/82; 315/172

(57) ABSTRACT

The present invention provides a light emitting diode light tube with two ends respectively having a pair of electrode pins for receiving a first and second AC input voltages. The light tube includes an AC switching power supply including a first input rectifier/filter circuit rectifying/filtering the first AC input voltage to generate a first rectified/filtered voltage, and a power conversion circuit coupled to the first input rectifier/filter circuit, and having a second input rectifier/filter circuit rectifying/filtering the second AC input voltage to generate a second rectified/filtered voltage, wherein the power conversion circuit generates a output voltage in response to the first and second rectified/filtered voltages. The AC switching power supply provides a constant output voltage and current to the LED, which avoids flicker in the LED light tube.

### BACKGROUND OF THE INVENTION

1. Field of the Invention

The present invention is related to an AC switching power supply, more particularly, to an AC switching power supply suitable for an LED light tube.

2. Description of the Prior Art

Light tubes are the indispensable household appliances in everyone's daily life. As the history of illumination developed from natural source of light, candles, oil light tubes, gas light tubes to electronic light tubes including the earlier tungsten light tubes and the modern energy-saving light tubes such fluorescent or LED light tubes, higher energy efficiency of the light source is important to human's daily life and a goal pursued in the technical field of illumination.

The modern light tubes are always power-supplied through a power conversion circuit since the utility power is in the form of alternate current. However, the output of a traditional power converter may vary with its input so that it can not provide a constant supply voltage or current to the light tube. An unstable supply voltage or current induces flickers of the light of the light tubes. People under such a lightning condition will be subject to eyestrain. Supplying power to the light tube through the traditional power converter can not get a satisfying effect when using the light tube.

Thus, the present invention provides an LED light tube and an AC switching power supply thereof for the problem described above, which eliminates the drawbacks in the prior art by supplying a more stable current to the light tube and improves the lightning condition for the users by avoiding flickers of the light of the light tube.

### SUMMARY OF THE INVENTION

One of the object of the present invention is to provide an LED light tube and an AC switching power supply thereof having a constant supply voltage and current achieved by an input rectifier/filter circuit and power conversion circuit, which avoids flickers of the light of the LED light tube.

Another one of the object of the present invention is to provide an LED light tube and an AC switching power supply thereof, wherein the high-voltage and the low-voltage components are isolated from each other by an isolated power conversion circuit to protect the users from electric shocks.

The present invention provides a light emitting diode light tube with two ends respectively having a pair of electrode pins for receiving a first and second AC input voltages. The light tube includes an AC switching power supply including a first input rectifier/filter circuit rectifying/filtering the first AC input voltage to generate a first rectified/filtered voltage, and a power conversion circuit coupled to the first input rectifier/filter circuit, and having a second input rectifier/filter circuit rectifying/filtering the second AC input voltage to generate a second rectified/filtered voltage, wherein the power conversion circuit generates a output voltage in response to the first and second rectified/filtered voltages. The AC switching power supply provides a constant output voltage and current to the LED, which avoids flicker in the LED light tube.

Further, According to one embodiment of the present invention, the power conversion circuit includes a feedback circuit generating a feedback signal in response to a status of the LED or an output voltage output from the power conversion circuit, wherein the output voltage output from the power conversion circuit is adjusted according to the feedback signal to stabilize the luminance of the LED.

### DETAILED DESCRIPTION OF PREFERRED EMBODIMENTS

FIG. 1 and FIG. 2 show an LED light tube and an AC switching power supply disposed therein according to one embodiment of the invention. The AC switching power supply 9 is disposed in the LED light tube 1 and coupled to the terminals 2 and 3 at one end of the light tube 1, and coupled to the terminals 4 and 5 at the other end of the light tube 1. The AC switching power supply 9 receives an AC input voltage AC_{IN1} through the terminals 2 and 3, and receives another AC input voltage AC_{IN2}, through the terminals 4 and 5 in order to output an output voltage for the LED in the LED light tube 1. This AC switching power supply is suitable for LED light tube.

As shown in FIG. 2, the AC switching power supply 9 receives the first and second AC input voltages AC_{IN1} and AC_{IN2} to generate the output voltage for a load 30, and includes a first rectifier/filter circuit 10 and a power conversion circuit 20. The load 30 may be at least an LED.

The first input rectifier/filter circuit 10 receives the first AC input voltage AC_{IN1} to output a first rectified/filtered voltage signal. The power conversion circuit 20 receives the first rectified/filtered voltage signal, has a second input rectifier/filter circuit 21 which receives the second AC input voltage AC_{IN2} to output a second rectified/filtered voltage signal. The first and second input rectifier/filter circuits 10 and 21 may be bridge rectifier/filters.

The power conversion circuit 20 further includes a transformer 22 and a switching circuit 23. The transformer 22 outputs the output voltage in response to the first and second rectified/filtered voltage signals. The switching circuit 23 is coupled to the transformer 22 and generates a switching signal controlling the transformer 22 to adjust the level of the output voltage. The switching circuit 23 is power-supplied by the first and second rectified/filtered voltage signals respectively from the first and second rectifier/filters 10 and 21. The switching circuit may be a PWM (Pulse Width Modulation) circuit.

The power conversion circuit 20 further includes an electrostatic discharge (ESD) protection circuit 25 having one end coupled to the first and second input rectifier/filters 10 and 21, and having the other end coupled to the transformer 22. The ESD protection circuit 25 protects the transformer 22 from ESD damage. The ESD protection circuit 25 is further coupled to the switching circuit 23 and also protects it from ESD damage. Due to such a circuit design, the first and second rectified/filtered voltage signals respectively from the first and second rectifier/filters are input to the primary side of the transformer 22 through the ESD protection circuit 25 so that the transformer 22 outputs the output voltage on its secondary side. The power conversion circuit 20 is an isolated power conversion circuit since the output voltage is output from the transformer 22, and the primary and secondary side of the transformer 22 are isolated from each other, i.e., the input voltage on the primary side is isolated from the output voltage on the secondary side, whereby the high-voltage and low-voltage components are isolated from each other. This protects users from being damaged by electric shocks.

The power conversion circuit 20 further comprises an output rectifier/filter 26 coupled to the output of the transformer 22 to rectify/filter the output voltage, whereby the output voltage supplied to the load 30 in the LED light tube 1 is more stable. In order to adaptively adjust the output voltage in response to the status of the load 30, the power conversion circuit 20 further includes a detection circuit 27 and a feedback circuit 28. The detection circuit 27 detects the status of the load 30 and accordingly generates a detection signal. For example, the load 30 may be an LED and the detection circuit 27 generates the detection signal in response to the luminance of the LED. The feedback circuit 28 generates a feedback signal to the switching circuit 23 in response to the detection signal, wherein the switching signal is generated by the switching circuit 23 in response to the feedback signal, i.e., the pulse width of the switching signal controlling the transformer 22 is determined by the feedback signal. Thus, the output voltage is adaptively adjusted in response to the status of the load 30.

The following is an example illustrating the adaptive adjusting of the output voltage by the operation of the detection circuit 27, feedback circuit 28 and switching circuit 23. When an insufficient luminance of the LED 30 is detected by the detection circuit 27, the feedback signal generated by the feedback circuit 28 in response to the detection signal causes increase of the duty of the switching signal from the switching circuit 23. The increase of duty of the switching signal further causes the increase of the output voltage output from the transformer 22. The LED 30 will be adjusted to have a higher luminance due to the increase of the output voltage. On the other hand, When an excessive luminance of the LED 30 is detected by the detection circuit 27, the feedback signal generated by the feedback circuit 28 in response to the detection signal causes decrease of the duty of the switching signal from the switching circuit 23. The decrease of duty of the switching signal further causes the decrease of the output voltage output from the transformer 22. The LED 30 will be adjusted to have a lower luminance due to the decrease of the output voltage.

Furthermore, the output current of the transformer 22 cab be kept constant by the operation of the detection circuit 27 and feedback circuit 28, whereby not only a stable output voltage but also a constant output current are supplied to the LED 30. Since the AC switching power supply provides a stable output voltage for the LED 30 without being affected by the variation of the first and second AC input voltages AC_{IN1} and AC_{IN2}, the LED light tube 1 is free from flickers and achieves a better lightning condition preventing the users from being subject to eyestrain.

FIG. 3 shows an AC switching power supply for an LED light tube according to another embodiment of the invention. With reference to FIG. 1 and FIG. 2 together, it is noted that the AC switching power supply in FIG. 3 is different from that in FIG. 2 by having the feedback circuit 28 directly coupled to the output end of the power conversion circuit 20 without the detection circuit 27. The feedback signal is generated in response to the output voltage output from the power conversion circuit 20. The duty of the switching signal from the switching circuit 23 is determined by the output voltage for the LED, rather than its luminance. When an excessive output voltage is detected by the feedback circuit 28, the feedback signal causes decrease of the duty of the switching signal from the switching circuit 23. The decrease of duty of the switching signal further causes the decrease of the output voltage. When an insufficient output voltage is detected by the feedback circuit 28, the feedback signal causes increase of the duty of the switching signal from the switching circuit 23. The increase of duty of the switching signal further causes the increase of the output voltage.

In conclusion, the present invention provides a light emitting diode light tube having a pair of electrode pins for receiving a first and second AC input voltages. The light tube includes an AC switching power supply including a first input rectifier/filter circuit receiving the first AC input voltage to output a first rectified/filtered voltage signal and a power conversion circuit receiving the first rectified/filtered voltage signal, having a second input rectifier/filter circuit which receives the second AC input voltage to output a second rectified/filtered voltage signal and outputting an output voltage in response to the first and second rectified/filtered voltage signals. The AC switching power supply provides a constant supply voltage and current to the LED, which avoids flicker in the LED light tube.

### BRIEF DESCRIPTION OF DRAWINGS

FIG. 1 shows an LED light tube with an AC switching power supply therein according ton one embodiment of the invention.

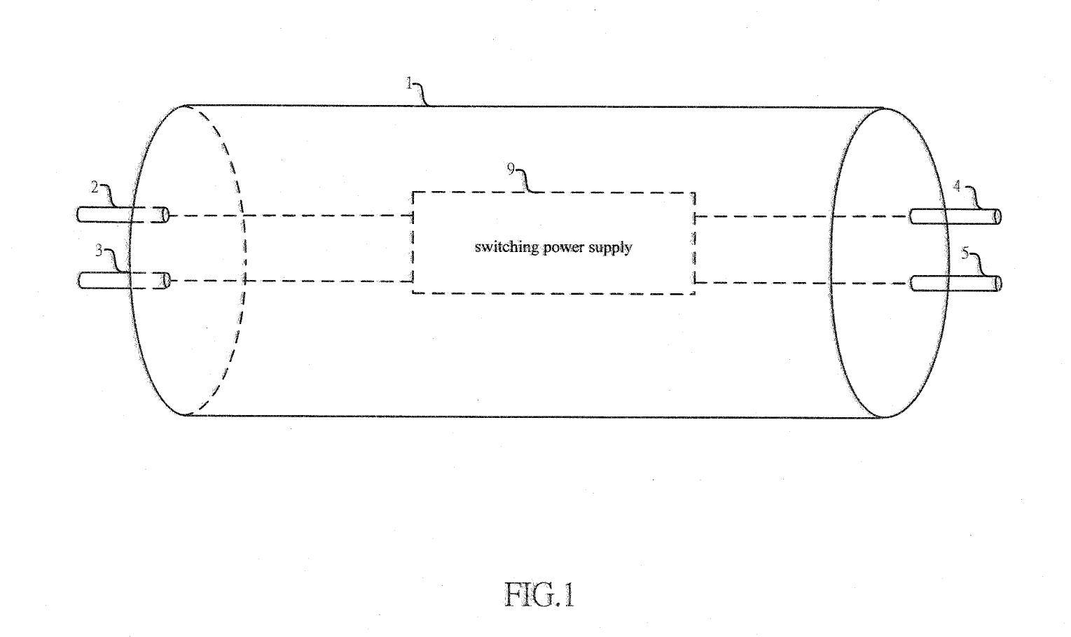

FIG. 2 shows an AC switching power supply for an LED light tube according to one embodiment of the present invention.

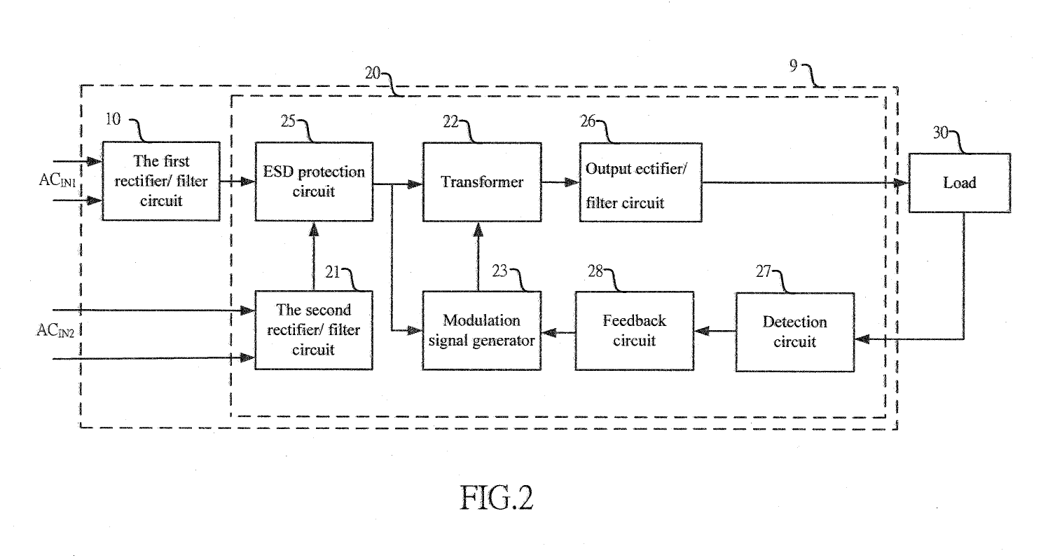

FIG. 3, shows an AC switching power supply for an LED light tube according to another embodiment of the present invention.

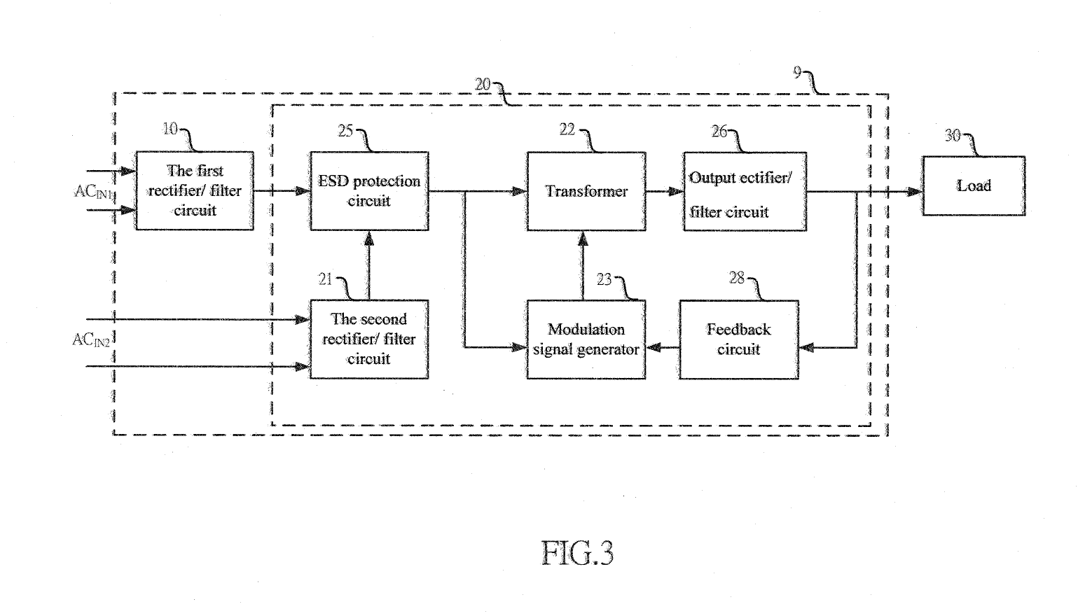

What is claimed is:

1. A light emitting diode light tube with two ends respectively having a pair of electrode pins for receiving a first and second AC input voltages, the light tube comprising:
an AC switching power supply comprising:
a first input rectifier/filter circuit rectifying/filtering the first AC input voltage to generate a first rectified/filtered voltage; and
a power conversion circuit coupled to the first input rectifier/filter circuit, and having a second input rectifier/filter circuit rectifying/filtering the second AC input voltage to generate a second rectified/filtered voltage;
wherein the power conversion circuit generates a output voltage in response to the first and second rectified/filtered voltages.

2. The light emitting diode light tube as claimed in claim 1, wherein the power conversion circuit comprises:
a transformer generating the output voltage in response to the first and second rectified/filtered voltages; and
a switching circuit coupled to the transformer and generating a switching signal for controlling the transformer.

3. The light emitting diode light tube as claimed in claim 2, wherein the power conversion circuit coupled to at least one LED provides the output voltage thereto.

4. The light emitting diode light tube as claimed in claim 3, wherein the power conversion circuit further comprises:
a detection circuit detecting a status of the LED and generating a detection signal in response to the status of the LED; and
a feedback circuit generating a feedback signal in response to the detection signal for controlling the switching circuit to generate the switching signal.

5. The light emitting diode light tube as claimed in claim 2, wherein the power conversion circuit further comprises a feedback circuit coupled to a output end of the power conversion circuit generates a feedback signal in response to the output voltage for controlling the switching circuit to generate the switching signal.

6. The light emitting diode light tube as claimed in claim 2, wherein the power conversion circuit further comprises an ESD protection circuit having one end coupled to the first and second input rectifier/filter circuits and another end coupled to the transformer.

7. The light emitting diode light tube as claimed in claim 1, wherein the power conversion circuit further comprises an output rectifier/filter circuit rectifying/filtering the output voltage.

8. A AC switching power supply comprising:
a first input rectifier/filter circuit rectifying/filtering a first AC input voltage to generate a first rectified/filtered voltage; and
a power conversion circuit coupled to the first input rectifier/filter circuit, and having a second input rectifier/filter circuit rectifying/filtering a second AC input voltage to generate a second rectified/filtered voltage;
wherein the power conversion circuit generates a output voltage in response to the first and second rectified/filtered voltages.

9. The AC switching power supply as claimed in claim 8, wherein the first input rectifier/filter circuit is a bridge rectifier/filter circuit.

10. The AC switching power supply as claimed in claim 8, wherein the second input rectifier/filter circuit is a bridge rectifier/filter circuit.

11. The AC switching power supply as claimed in claim 8, wherein the power conversion circuit comprises:
a transformer generating the output voltage in response to the first and second rectified/filtered voltages; and
a switching circuit coupled to the transformer and generating a switching signal for controlling the transformer.

12. The AC switching power supply as claimed in claim 11, wherein the power conversion circuit coupled to at least one LED provides the output voltage thereto.

13. The AC switching power supply as claimed in claim 12, wherein the power conversion circuit further comprises:
a detection circuit detecting a status of the LED and generating a detection signal in response to the status of the LED; and
a feedback circuit generating a feedback signal in response to the detection signal for controlling the switching circuit to generate the switching signal.

14. The AC switching power supply as claimed in claim 13, wherein the status of the LED is a luminance of the LED.

15. The AC switching power supply as claimed in claim 11, wherein the power conversion circuit further comprises a feedback circuit coupled to a output end of the power conversion circuit generates a feedback signal in response to the output voltage for controlling the switching circuit to generate the switching signal.

16. The AC switching power supply as claimed in claim 11, wherein the first and second rectified/filtered voltages are used as supply voltages of the switching circuit.

17. The AC switching power supply as claimed in claim 11, wherein the power conversion circuit further comprises an ESD protection circuit having one end coupled to the first and second input rectifier/filter circuits and another end coupled to the transformer.

18. The AC switching power supply as claimed in claim 11, wherein the switching circuit is a Pulse Width Modulation (PWM) generator.

19. The AC switching power supply as claimed in claim 8, wherein the power conversion circuit further comprises an output rectifier/filter circuit rectifying/filtering the output voltage.

20. The AC switching power supply as claimed in claim 8, wherein the power conversion circuit is an isolated power conversion circuit.
